(19) United States
(12) Patent Application Publication
(10) Pub. No.: US 2012/0102571 A1
(43) Pub. Date: Apr. 26, 2012

(54) SYSTEM AND METHOD FOR DIGITAL FORENSIC TRIAGE

(75) Inventor: Andrew David Sheldon, Milton Keynes (GB)

(73) Assignee: EVIDENCE TALKS LIMITED, London (GB)

(21) Appl. No.: 13/320,173

(22) PCT Filed: May 13, 2010
(86) PCT No.: PCT/GB2010/000970

§ 371 Date: Jan. 3, 2012

(30) Foreign Application Priority Data
May 13, 2009 (GB) 0908146.4

(51) Int. Cl. G06F 21/00

(52) U.S. Cl. 726/26

(57) ABSTRACT

A digital forensic system for performing forensics on a target device comprises a control pod and a collection device. The control pod, which has a unique identity in order to enable accurate audit, is arranged to register and allocated a unique identity to the collection device and to clean, load a profile onto the collection device, the profile defining a subset of data. The collection device is connected to the target device and copies data from the target device to the collection device according to the profile. The control pod is then arranged to create a report on the collection device, the report derived from the copied data. Once a user input has been received, indicating that the collection device be marked as evidence, then the control pod is arranged to lock the collection device in response to the user input.

This invention relates to a digital forensic triage system and to a method of operating the system. The invention improves on known art by reducing the opportunity for the user to make or introduce errors into the data and review collection process. In one embodiment, the method and process is embodied in hardware and software to enable persons with little or no forensic or technical knowledge to forensically collect and review data from a target device such as a digital storage media in a manner that guides, and controls the novice user's actions in a manner that improves significantly upon known forensic triage techniques, resulting in the collected data and output from the system being more likely to be acceptable as potential evidence in civil or criminal legal proceedings.

Digital forensic examinations are performed in order to obtain evidence related to criminal offences or abuse of corporate or home based computing (IT) systems. There are a number of globally accepted principles which apply to performing digital forensic examinations. Foremost of these are the need to prevent changes to the data being examined and to maintain a record of any actions taken during the examination. In many circumstances, the speed of forensic response is also critical.

Performing digital forensic analysis requires specialist software and hardware which is usually operated by skilled and trained staff. In circumstances where a skilled forensic analyst is able to gain physical access to the computer containing the media to be examined, it is common practice to remove the media to be examined and connect it to a forensic imaging device via an interface that is designed specifically to prevent changes being made to the device being examined. This type of device is commonly referred to as a “write blocker”, and its purpose is to maintain the integrity of the data being examined by preventing any changes being made to it during the forensic imaging or analysis process.

An accepted and commonly used alternative method of preventing modification to the data being examined is to access the storage device containing the data using a software “write blocked” environment where the media under examination is accessed in a “read only” state. This is commonly achieved by “booting” a computer to which the target storage device is connected using a modified “boot device” such as a CD containing a variety of a Linux or other suitable operating system, or by attaching a target storage device to a computer and accessing the target device in a read only state.

However, it is often the case that skilled forensic examiners are not available at the point of examination of the target device or cannot process the required target device(s) in a suitable time frame. Similarly, under some circumstances, all that may be required is to quickly and efficiently review a number of target systems to establish if they are likely to contain material of interest to an investigation. Such reviews are often referred to as “forensic triage” reviews and must be performed using forensically acceptable methods in order that any evidence that is identified during the forensic triage process is not damaged, modified or contaminated, literally or from a legal perspective, by the process of acquiring and reviewing the evidence.

The lack of skilled forensic staff available to perform forensic triage, at the point where target systems and data to be examined are found, often leads to suspect systems either being ignored completely or “seized” and removed to a dedicated forensic laboratory where a forensic analyst can perform the analysis of their content, often incurring significant time delays. A forensic triage process must enable a user to access the target system in a manner that prevents accusations that the process, or the individual operating the process, has modified the contents of the data being examined. Similarly, the process steps and analysis results must be recorded in a manner that permits them to be produced as evidence of the actions taken by the person performing the triage act.

There are a number of existing solutions that do not rely on a trained forensic analyst physically performing the analysis, but do rely on a person with some training to use various software and hardware tools designed to collect the target data and perform various analysis of the target data.

One known digital forensic triage technique involves attaching an external digital storage device into a target computer via a USB or similar port on the target computer, while the target computer is powered on and running. A software program stored on the external device is run in the memory of the target system and collects nominated data from the target computer or creates a log containing details of the nominated data on the target computer. The information recovered by the software application is stored on the external device for later review using appropriate tools.

A second solution is to install an external storage device into the target computer via a USB or similar port on the target computer while the target computer is powered on and running. A software program stored on the external device is run and performs keyword or other searches of the data on the target computer and copies files containing the keywords or otherwise matching the search criteria from the target computer onto the external storage device or creates a log on the external device containing details of the files meeting the search criteria on the target computer. The information recovered by the software application is stored on the external device for later review using appropriate tools.

Yet another solution is to install an external storage device into the target computer via a USB or similar port on the target computer while the target computer is off and also inserting a “boot” CD into a CD reader installed in or attached to the target computer. When power is applied to the target computer it is instructed to read an operating system from the CD and to use this operating system instead of its own operating system. In this manner it is possible to access the data on the hard disk of the target computer in a read only mode thereby preventing any changes to the data under examination. Once the system is running, a software application either on the CD or on the external storage device can be used to search for data and extract the data to the external storage device or create a log containing details of the data found and then store the log on the external storage device for later review using appropriate tools.

There are several drawbacks to the current known solutions. For example, it is not always possible to prevent collected data that is stored on an external storage device from being contaminated by data that has been previously collected and stored on the same external collection device. Secondly, it is not always possible to ensure that devices used for collecting data are forensically cleaned before use, which is a fundamental principle of digital forensic best practice. The current known solutions do not provide a mechanism for ensuring only authorised and uniquely identifiable external data collection devices are used and cleaned and verified to forensic standards prior to being deployed. It is also a forensic best practice that all use of such devices is logged and that such a log can be produced as evidence of the is device usage history if required. Existing systems that do enforce devices are forensically cleaned and verified before they are used do not maintain a lifetime log of the device history. Failure to do this can lead to claims that the data collected from the target device has been contaminated by previously collected data.

Known solutions have a lack of a comprehensive audit trail. Current solutions lack a comprehensive auditable usage history associated with data collection devices and the steps taken to acquire data from target devices. It is accepted best practice in a forensic laboratory that a storage device being used to store data of potential evidential value is first uniquely identified and then adequately cleaned of all previous data and that this cleaning process is verifiable and an audit record is maintained of the device usage history.

Current solutions do not have a controlled, read only, audited and secure access to collected data. Yet another drawback of known systems is the lack of control over access to the data that has been retrieved from a target system. Typically, current solutions require the external storage device on which recovered data is stored to be connected to a PC running analysis and reporting software. It is possible that no measures, such as write protected interfaces, are enforced to prevent the recovered data from being changed during such actions. All known system appear to rely on the knowledge of the operator to have and use read only interfaces.

Protection of data from unauthorised access is not always provided in known solutions. Likewise, when such analysis and reporting software is run on the recovered data there are no mechanisms to prevent copies of the target data becoming stored on the analysis computer. In the current systems, any computer provided by the operator can have the analysis software installed on it and there is no control over the subsequent removal of any data fragments from this analysis computer. This may result in sensitive or confidential data from the target system being left on the computer used for analysis and reporting. This in turn could open the results obtained using the system to questions of evidential contamination.

An example of an existing system is disclosed in International Patent is Application Publication WO 2007/067424, which discloses a forensics tool for examination and recovery of computer data. The electronic forensic tool is for conducting electronic discovery and computer forensic analysis. The electronic discovery involves a software program and a command server for generating expanded functionality. The client software may be distributed at minimal or no cost, preferably as a CD. Using the client software, a user boots a target machine to determine whether a target machine contains data of interest. The client software will, however, only display limited data such as file information, date, last modified, and file size. To access and examine the actual underlying data, the user must obtain additional functionality, for example by purchasing a command block from the control server. The additional functionality will allow the client program to extract the data of interest or the entire contents of the target machine to an external device for further analysis.

WO 2007/067424 describes a three part technology involving a payload, a server and a “control block”. A payload (or client program) which is stored only on a portable memory device such as a USB device is deployed against a target device by loading it onto a target device, thereby loading it into the memory of a target computer and determining a unique identify for the target device storage. The control server is used to create and issue command blocks that will only work against the target device with the unique identity created by the client program. The command block acts as a configuration file to enable the functionality of the client program to collect specific data from the specified target device.

There are a number of weaknesses with the system described in WO 2007/067424. For example, the system does not provide for the traceability of the storage devices or the device used to configure the storage device. The system relates only to a client program searching a data storage device of a lo target device, which means that the program must be installed in the memory of a target computer from where it searches the storage connected to the target computer. This therefore provides a system that uses the processing capabilities of the target device to scan, identify and create reports on the data found on the target device. The system relates only to collecting and processing data from a computer environment. It cannot search standalone storage such as loose hard disks, USB memory sticks or memory cards. The system works by using command blocks which are downloaded from a server onto a USB storage device and which enable the client program to perform certain actions, such as searching for certain keywords. Specifically, the system requires the USB device to be plugged into a target computer before it can work. This does not provide sufficient evidential traceability for the search and recovery of material from the target computer.

It is therefore an object of the invention to improve upon the known art.

According to a first aspect of the present invention, there is provided a digital forensic system for performing forensics on a target device comprising a control pod with a unique identity, and a collection device with a unique identity, wherein the control pod is arranged to register the collection device with the control pod using the unique identities, the control pod is arranged to clean the collection device, the control pod is arranged to load a profile onto the collection device, the profile defining data to be collected, the collection device is connected to the target device, the collection device is arranged to copy data from the target device to the collection device according to the profile, the control pod is arranged to create a report on the collection device, the report derived from the copied data, the control pod is arranged to receive a user input indicating that the collection device be marked as evidence, and the control pod is arranged to lock the collection device in response to the user input.

According to a second aspect of the present invention, there is provided a method for operating a digital forensic system for performing forensics on a target device, the system comprising a control pod and a collection device, each with a unique identity, the method comprising the steps of registering the collection device with the control pod using the unique identities cleaning the collection device, loading a profile onto the collection device, the profile defining data to be collected, connecting the collection device to the target device, copying data from the target device to the collection device according is to the profile, creating a report on the collection device, the report derived from the copied data, receiving a user input indicating that the collection device be marked as evidence, and locking the collection device in response to the user input.

Owing to the invention it is possible to provide a digital forensic process and system that will provide control of the entire process and the devices used to collect and process data. The invention provides the use of a dedicated computer which is uniquely identifiable (the control pod) to create uniquely identifiable collection devices which are registered to a specific control pod. By using the control pod to analyse the data after it has been collected by the collector rather than using the target device, evidential and process integrity are maintained. The invention also provides the ability to collect data from non-computer attached storage. The control pod can be used as a host to allow data collection from any form of external storage with a suitable connection such as USB, Firewire or network connection, and the process does not need to install anything on the target device in such scenarios. Under no circumstances is the processing power of any target device used to perform forensic analysis such as keyword searching. In the invention, any analysis is performed using the control pod after the capture of data. Prior art systems use the target computer to review the collected data. The process of this invention never uses the host to act as a review machine, for example because the power or capability of the host machine cannot be known. The control pod is always used as the review platform giving better control of the evidence.

The process improves on known forensic triage art by automatically applying unique identities to the hardware used (the control pod and the collector devices) which vastly improves control, auditability and reliability of any subsequent evidence, allows collection of data from non-computer devices such as memory cards and thumb drives by using the control pod to directly interface to the target device, and dramatically improves data collection and triage performance by not performing forensic analysis (other than simply identifying the data to collect) on the target device. The process improves on known triage art by simply collecting data on the target then bringing it back to the control pod and processing it in a known, optimised environment. The above key points are in addition to the ability to provide remote viewing and/or remote forensic analysis.

The nature of the system ensures that only collection devices that are properly approved, registered and audited can be used with the system. Both the control pod and the collection device are provided with respective unique identities, such as encrypted signatures. Preferably, the control pod is arranged to allocate the unique identity to the collection device. This is to prevent the use of uncontrolled devices, perhaps with unknown history to be used for the collection of potential evidential data. The software on the control pod is used to create a data collection configuration which the control pod can then place on the collection device together with a copy of the collector payload software. The system ensures that when a collection device is deployed to collect data it accesses the target data in read only mode. The process also permits collection from a computer that is powered on and running. In this case, it may not be possible to access the data in read only mode but in which case measures are taken to minimise the changes the process may make to the contents of the storage. The system may preferably record an audit log of the changes the process has made to the contents of the storage media as part of the audit trail.

When a collection device is deployed to collect data, it has the ability to request certain information from the user such as the user's identity, the contemporaneous date and time and details about the target device and other relevant data. When a collection device collects data from a target device, it can collect that data in a number of different ways including by copying it on a file by file basis or by using existing forensic data imaging and verification lo techniques and software. When a collection device containing collected data is attached to the control pod the control pod prevents modification of the collected data on the collection device by accessing it in READ ONLY mode. After a collection device has been used to collect data from a target device it may subsequently be connected to a digital forensic workstation and that data may be processed using any existing forensic processing techniques.

When a collection device containing collected data is attached to the control pod the only options for the user are to instruct the control pod to perform automated processing of the data against certain pre-defined processing objectives, to re-configure the collection device to collect more data or to forensically erase the data and re-configure the collection device for re-use. When a user instructs the control pod to perform automated processing of collected data the results of that processing are stored onto the collection device and not on the control pod.

When a collection device containing collected and processed data is attached to the control pod the only options for the user are to review the reports generated by the control pod which are stored on the collection device or to digitally mark the collection device as evidence or to reconfigure the collection device for re-use or to forensically erase the data and re-configure the collection device for re-use. Once a collection device is digitally marked as evidence it cannot be re-used without first being unmarked as evidence. All actions performed on a collection device are preferably recorded in a log file and that standard digital hashing techniques are used to ensure that changes to the log files after they have been created can be detected.

In a preferred embodiment, the control pod is provided with a dedicated network port and associated software that can be used to provide remote access to the control pod by someone with specific analysis or technical skills or by someone who needs to see the collected data urgently. The network port can be connected to any convenient facility that provides a suitable IP address and the appropriate software on the control pod can be used to request a remote user to gain access via a VPN connection to the control pod while providing suitable authentication and access controls.

The invention provides a system, preferably comprising hardware and software, which enables an operator with little or no forensic or technical skills to perform forensic imaging, data collection and analysis of digital media using dedicated forensic equipment while maintaining an auditable trail of actions, in order to provide evidential continuity. The invention preferably includes a method of recording the actions taken by the users of the system for the purpose of maintaining a contemporaneous log of actions to show the sequence of events that led to the services being performed.

The invention preferably provides a system that enforces the use only of properly authorised collection devices and that maintains a lifetime history of the use of each device and that each collection device contains a detailed log of its use. The data collected from a target system is protected from unauthorised access, modification or contamination by using the hardware and software to perform the analysis and reporting functions. The data is stored on the collection device in a format that prevents it being accessed by normal computer operating systems. The analysis and reporting of the collected data is performed only on the hardware of the system using the dedicated software which ensures that, when the hardware is powered off, preferably any residual data in volatile memory and in disk based virtual memory is wiped.

Given that one intended use of forensic triage solutions is to allow relatively un-skilled users to deploy them, it is advantageous that the solution controls the process at all possible points and aims to prevent a user from bypassing any protection mechanisms in place to preserve the potential evidence. The system and process embodies a sequence of tasks that enforce a forensically acceptable collection, analysis and review capability that can be used by someone after minimal training without risk to any potential evidence.

The system comprises both hardware and software components which together allow the user to use one of the hardware components together with its associated software, referred to collectively as the control pod, to prepare, to digital forensic standards, a digital collection device and, using a series of pre-built configuration options embedded in the control pod, configure software on the collection device, referred to as the collector payload, to collect data from a target device for the purpose of conducting analysis of the collected data in a manner that satisfies common digital forensic principles and best practice.

The system enables such users to collect data from a range of digital devices including computers, hard disks and digital storage devices with a USB, Firewire or network interface including but not limited to devices such as MP3 players, laptop computers, network servers and USB memory sticks using forensically acceptable processes and in accordance with digital forensics best practices which are embodied in the software and hardware of the system. The system enables data to be collected using a number of methods including by attaching a configured collection device to a target computer or by attaching a target device to one of the write protected interfaced built into the control pod.

The system forces the collected data to be collected and stored onto uniquely identifiable collection devices, whose use is controlled and logged by the control pod hardware and software, in a format that protects the collected data from change, contamination and un-authorised copying. Once data has been collected onto a collection device it is attached to the control pod and the control pod hardware and software perform automated analysis of the collected data stored on a collection device using analysis logic embodied in the control pod software, in a manner that protects the collected data from change, contamination and un-authorised copying. The control pod software automatically produces reports, relating to the collected data and the process used to collect it, which are created and stored on the same collection device but in a manner which prevents the collected data from change and contamination.

Each collection device is uniquely identified and the control pod software maintains a log of the use of all collection devices that have been used on it. Likewise, each collection device contains a log of actions it has been subjected to since it was last forensically cleaned.

The system provides a novel combination of hardware and software embedded in the control pod and collection device which guides an authorised user through a mandatory process for preparing a uniquely identifiable data collection device prior to the device being used to collect data from a target device. This is achieved by deleting the contents of its storage space and overwriting it with a known pattern of data to forensically acceptable standards. This wiping process is then verified by the equipment as having removed all previous data. The collection device cannot be deployed without passing this verification process.

The next step in the process is configuring the collector payload software on a collection device to perform data collection and/or the recovery of data from a target device via a USB or Firewire connection or similar without installing anything on the target device. Optionally, the collector payload may be software running on the control pod which is deployed on target devices connected directly to the control pod via USB, Firewire or Network interfaces but which stores its collected data on a collection device. Other suitable interfaces can be used, such as eSATA, SATA and SCSI.

This is followed by deploying the collection device on the target device in a manner that prevents changes to the contents of the target device. Optionally, deploying the collector payload on the control pod against target devices connected directly to the control pod via USB, Firewire or Network connections. The process continues by analysing the data obtained from the target device which is stored on the collection device in a manner that prevents changes to the collected data on the collection device and storing the results of such analysis on the same collection device. The collected data is automatically subjected to a pre-defined series of data processing analysis tasks focussed on extracting and formatting data that is commonly examined during a digital forensic investigation such as images, documents, Windows registry settings, user accounts, internet browsing records, file sharing records, email and general file and system usage records. Such analysis results in the generation of an interactive report that is displayed to the user on a screen built into or attached to the control pod.

It is then possible to review the results of the automated analysis and processing tasks by using an interactive reporting format that presents the results data in a logical and ordered format that allows the user to peruse a basic view of the information before accessing more detail about a specific item of interest. For example, the report may have an icon indicating PICTURES. By clicking on the icon, a series of thumbnail images of pictures are displayed to the user organised in descending size order. Using this technique, it is more likely that the user will see images taken by a digital camera and copied onto the target device before they see images copied from a website. By clicking on a particular image, they are presented with details of the image file such as its name, creation, modification and last access dates, size, file hash values such as MD5 and/or SHA1 hash value and its storage location. Likewise, documents may be presented for review in order of type, storage location or most recently accessed.

Preserving of the collected data as potential evidence is carried out by optionally selecting an option presented by the control pod software to mark the collection device and all data on it as evidence. By selecting this option in the control pod software, the user is prompted for a unique “exhibit” identifier and provided with the option to enter text notes then the device is digitally “sealed”, optionally encrypted and identified by the control pod software as “EVIDENCE”. In this state the contents of the collection device are protected from change and the device cannot be wiped or reconfigured for collection by a control pod without the intervention of the control pod administrator user, who can reset the device to be re-usable. When marked as EVIDENCE, the only action permitted by the control pod on the collection device is viewing of the reports stored on the collection device.

To prevent data stored on a collection device from being deliberately or inadvertently modified or copied from the device, the storage space on the collection device is divided into a number of separate partitions each formatted using proprietary, encrypted and/or unusual disk formats designed to prevent their data structures being identified by standard operating systems such as Microsoft Windows. The original collected data and the automatically generated reports are stored in different partitions. The partition containing the original collected data is always accessed in READ ONLY mode by the Control pod software.

The term services refers to, but is not restricted to, performing the following tasks, digital forensics, forensic imaging and forensic analysis. Digital forensics is the term given to the process of examining digital storage media for the purpose of identifying and analysing data. Commonly, digital forensic examination of storage media may be required when investigating computer systems and or networks that have, for example, been associated with criminal activity or have been the target of abuse or misuse.

Forensic imaging is the process of creating a trusted copy of an item of digital storage media in such a manner that the imaging process is non-invasive to the original media and the process and resultant data can be verified as being an accurate representation of the original media. Following the process of forensic imaging, the resultant data is known as a forensic image. Forensic analysis is the process of examining the contents of data stored on digital media using specialist software in a way that allows conclusions to be drawn about the data. Forensic triage is the term used to describe the performance of any of the services on items of digital media.

Specialist software is any software that the user may use to perform digital forensic imaging, forensic analysis or data recovery. For the purpose of this document, the term specialist software may also refer to software used for forensic imaging and also for forensic analysis and data processing.

A network is the term used to describe a collection of two or more devices connected using a communications protocol. The Internet is the term used to describe a publicly accessible global network of networks providing access to multiple networked resources. An Intranet is the term used to describe a private network of networks which provides access to selected networked resources. A VPN (Virtual Private Network) is a private data network that makes use of a network infrastructure, maintaining security and privacy through the use of a various protocols and security procedures.

A target computer (or target device) is any device which contains media that has been identified as requiring the services. For the purpose of this application, the term target computer includes any device that has digital storage attached to it and is not restricted to being a PC or other such computing device. Storage media is any device on which data is stored. For the purpose of this document, the term storage media may refer to, but not be limited to, hard disks, floppy disks, CDs and DVDs, USB removable storage devices and other solid state storage devices.

Embodiments of the present invention will now be described, by way of example only, with reference to the accompanying drawings, in which:—

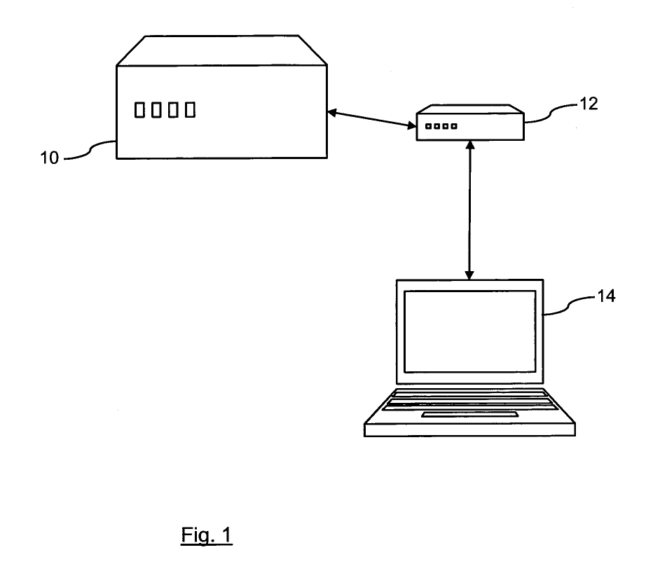

FIG. 1 is a schematic diagram of a forensic triage system and a target device,

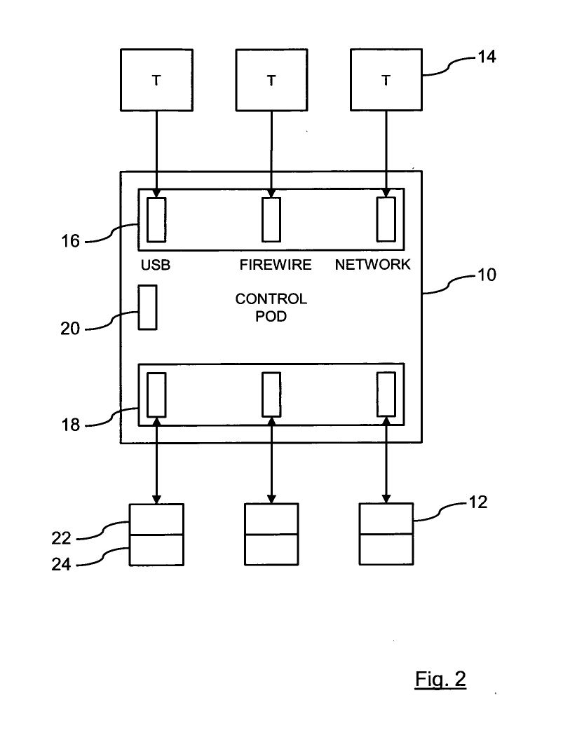

FIG. 2 is a more detailed schematic diagram of the forensic triage system,

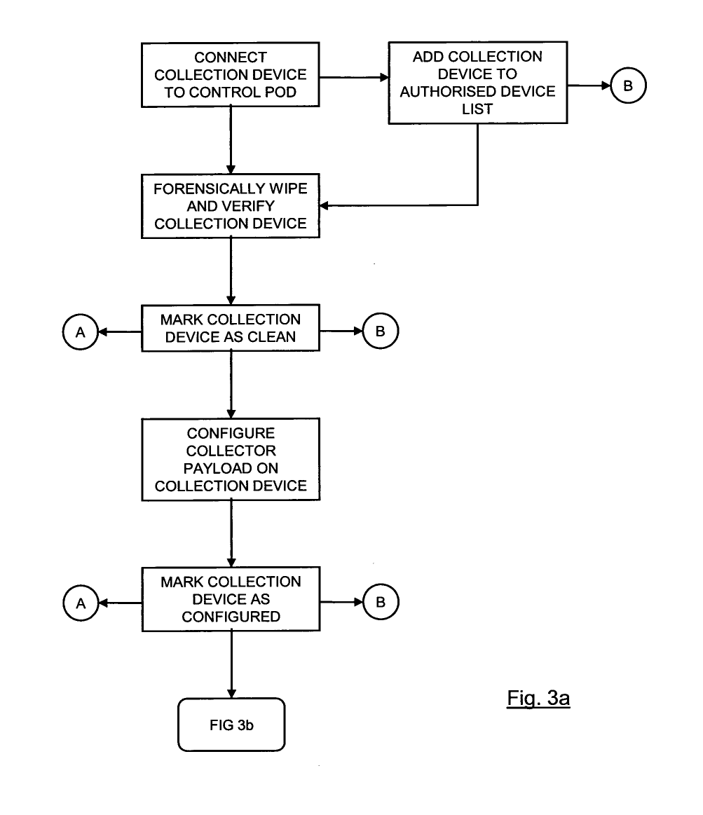

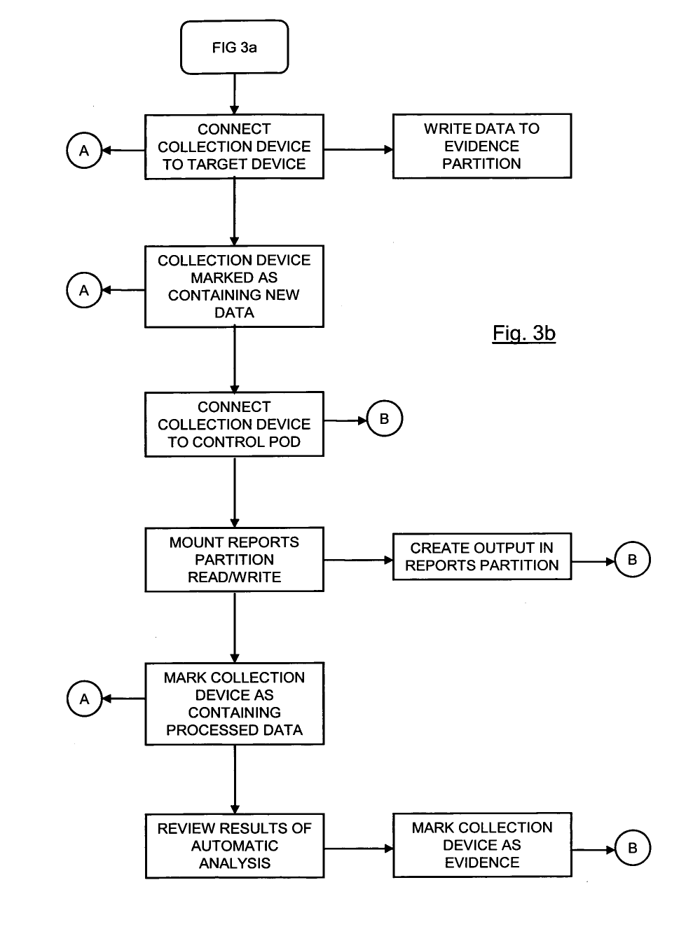

FIG. 3 is a flow diagram of a method of operating the system, and

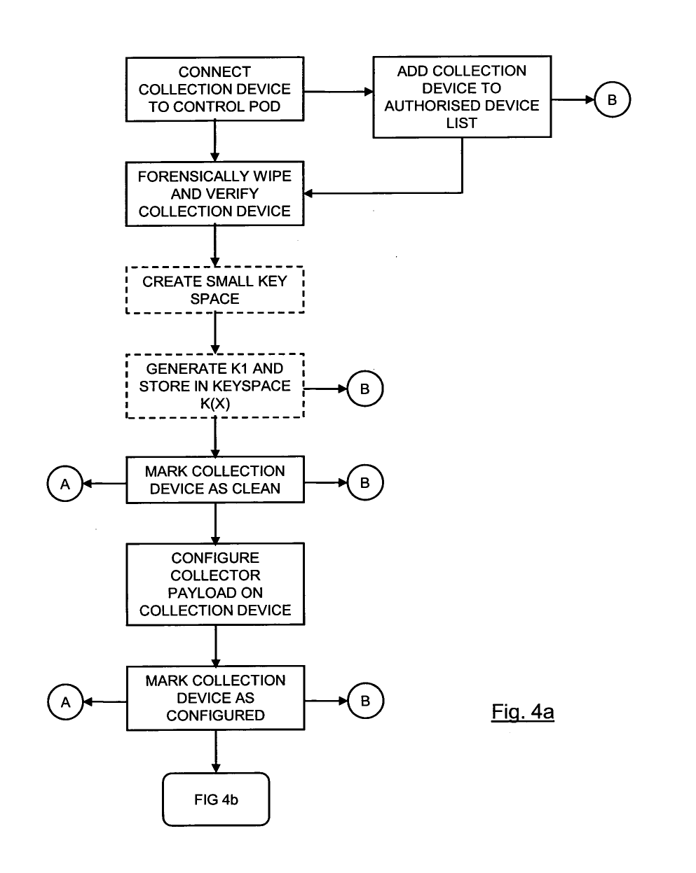

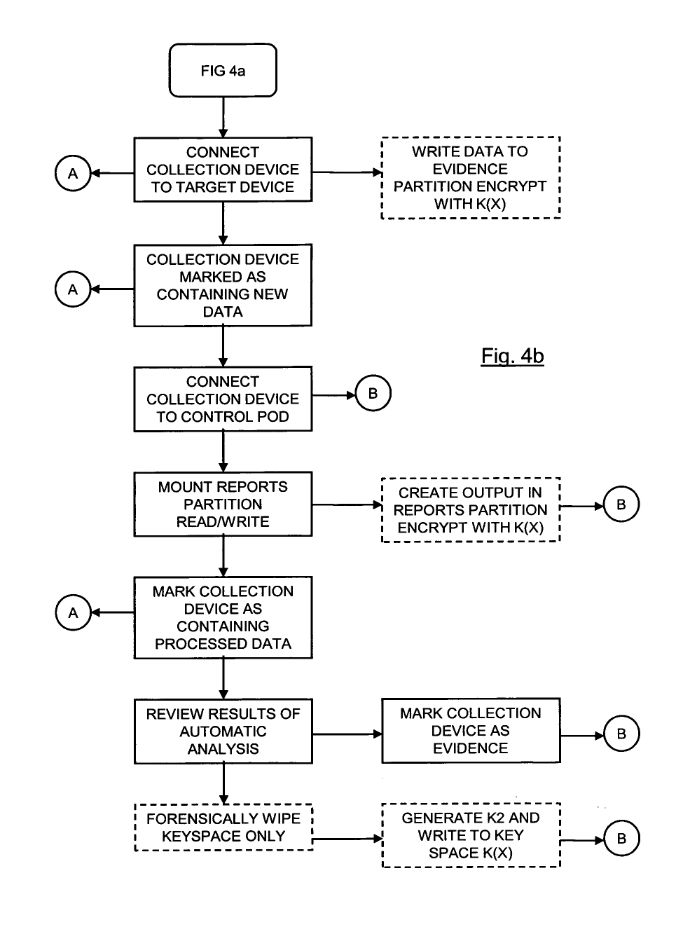

FIG. 4 is a flow diagram of an alternative method of operating the system.

FIG. 1 shows a digital forensic system comprised of a control pod 10 and a collection device 12. The system is for performing a forensic examination of a target device 14. The target device 14 is shown as a laptop computer 14, but could be any device that is capable of storing any kind of digital media, such as a digital camera or a USB key etc. The system is designed to perform a forensic triage on the target device 14. The forensic triage examination is one that will determine whether there is a likelihood of relevant material being found on the target device 14 by examining a subset of the files stored on the target device 14.

In order to improve on the known systems, a forensic triage methodology is embodied in the system of FIG. 1, which avoids the issues and limitations identified in the prior art. The triage process comprises a combination of software on the collection device 12, called the collector payload, which can be configured to collect data from the target device 14 according to specific collection criteria, and software on the control pod 10 that enforces a structured and repeatable forensic triage methodology. Data is recovered from the target device 14, which is then stored on the collection device 12 in a manner that preferably does not leave any trace on the target device 14, does not alter the recovered data and is carried out under the is control of the control pod 10.

The system performs, among others things, various processes. The system provides a method for user administration, security and control, ensures only authorised collection devices 12 are used, forensically cleans data from used collection devices 12, verifies collection devices 12 are clean before configuration, creates storage partitions on collection devices 12 ready for use, allows collection criteria to be created, edited, deleted, copies collection criteria and the payload to a collection device 12, creates current usage logs on each collection device 12, records usage history logs for all collection devices 12, accesses collected data as read only on collection devices 12, performs analysis of collected data on collection devices 12, creates reports about collected data on collection devices 12, stores reports on the same collection device 12 as the collected data, ensures removal of residual collected data from the control pod 10, creates an audit trail of user actions on the control pod 10 and allows collection devices 12 to be marked as evidence with notes.

The forensic system is for acquiring and reviewing data from a target device in a manner that enforces the accepted forensic best practices for the preservation of digital data as potential evidence. Likewise, the system is for maintaining evidential continuity and ensuring data integrity, for controlling access to the collected data and for providing a structure for the presentation and reporting of data from target devices. The system enforces a structured and auditable process that can be used by operators with little or no technical skill or understanding and provides secure, remote access to the control pod 10, via a network, to allow skilled analysts to examine the acquired data stored on a collection device 12 or target device 14 connected to the control pod 10.

The system enables the controlled and audited collection of data stored m on target devices 14 such as computers, external USB storage devices, memory cards, MP3 players, digital cameras and other such devices using forensically acceptable techniques. As discussed, the system comprises two main components, the control pod 10 and its associated software and the collection devices 12 and their associated software.

The control pod 10 comprises a computer and associated components together with a number of interface ports such as USB, Firewire, memory card and network connection interface ports. The control pod 10 also contains an operating system and specialist software (the control pod software). By way of example, the control pod 10 could be a desktop, handheld or laptop computer or a computer built into a rugged case with a screen and keyboard and a number of interface ports such as USB, Firewire and Network ports. The control pod 10 can be mains or battery powered and the network connections can be used to gain access to local area networks or the Internet.

The collection devices 12 are digital storage devices with USB, Firewire or other such connection interfaces and which have associated software (the collector payload) installed on them at the time of configuration which is configured by the control pod 10 to perform the identification and collection of data from a target device(s) 14. By way of example, a collection device could be an external self powered hard disk or a USB memory stick with USB or Firewire interfaces.

Target devices 14 are devices that are likely to contain data to be examined and can take many forms such as computers, external USB or Firewire hard disks, USB memory sticks, memory cards such as those found in cameras and mobile phones. In one implementation of the system, if the target device 14 is a computer such as a laptop, server or desktop, the method of collection involves plugging an appropriate collection device 12 into a convenient USB or similar interface port on the target device 14 and placing a boot CD into a CD reader attached to the device 14 and booting the device from an operating system on the CD.

In one implementation the collection device 12 may also contain a separate storage partition containing an operating system and an interface that makes this partition appear to the target computer 14 in the same way as a CD device would appear, and thus allowing the target computer 14 to boot from the operating system partition on the collection device 12 in the same way as it would from a CD. The collector payload software on the collection device 12 is launched and performs the tasks it is instructed to perform by its configuration.

In another implementation of the system, if the target device 14 is a computer such as a laptop, server or desktop, the method of collection involves plugging an appropriate collection device 12 into a convenient USB or similar interface port on the target device 14 and booting the target device from an operating system on the collection device 12. The collector payload software on the collection device 12 is then launched and performs the tasks it is instructed to perform by its configuration.

In another implementation of the system, if the target device 14 is a computer such as a laptop, server or desktop, the method of collection involves plugging an appropriate collection device 12 into a convenient USB or similar interface port on the target device 14 and also connecting one end of a network cable to a network port on the target device 14 and connecting the other end of the network cable to a network port on the control pod 10 and booting the target device 14 from an operating system on the control pod 10. In this implementation, the collector payload software which can be either on the control pod 10 or on the collection device 12 is then launched and performs the tasks it is instructed to perform by its configuration. The resultant data is stored on the collection device 12.

In a yet further implementation of the system, if the target device 14 is an item of storage such as an external memory stick or memory card or an external hard disk and the item is not attached to a computer, the method of collection involves plugging the target device 14 directly into an appropriate port fitted to the control pod 10, which is specially configured to operate in READ ONLY mode, and also plugging a collection device 12 into a convenient USB or similar interface port on the control pod 10. In this implementation, the collector payload software which can be either on the control pod 10 or on the collection device 12 is then launched and performs the tasks it is instructed to perform by its configuration. The resultant data is stored on the collection device 12.

FIG. 2 shows more detail of the control pod 10 and collection device 12. The control pod 10 includes write-protected interfaces 16 for connecting directly to target devices 14. The control pod 10 also includes read/write interfaces 18 for connecting to the collection devices 12. The control pod 10 further includes a network connection 20 for remote access to the control pod 10. In the preferred embodiment, the control pod 10 comprises storage slots for physically storing the collection devices 12. Each collection device 12 is partitioned into two parts. A first partition 22 is for storing the original evidence recovered from the specific target device 10 and the second partition 24 is for storing the results of the analysis of the data in the first partition 22 and any report data. The control pod 10 and the collection devices 12 each store respective unique identities that are used when a collection device is registered to a control pod 10.

The system also provides a method for ensuring that the operators of the system follow a repeatable and auditable series of steps in order to use the control pod 10 and collection devices 12 to collect and review data from a target device 14 in a forensically acceptable manner. One part of this method ensures that all of the collection devices 12 are uniquely identifiable and are cleaned of data to a forensically acceptable standard before they can be used to collect and store data from a target device 14. This is to ensure that data collected from a target device 14 cannot be contaminated by data stored on the collection device 12 during a previous data collection process.

A part of the method operated by the system ensures that a log containing the usage history of each collection device 12 that has been attached to the control pod 10 is maintained. This is to enable a complete usage history of a collection device 12 to be produced even if the collection device 12 has been used on one or more control units 10. A log containing the usage history of the collection device 12, since the last time it was cleaned, is stored on the collection device 12. This is to enable a usage history of a collection device 12 from the last time it was cleaned to be produced if required.

FIG. 3 illustrates the method of operating the control pod 10 and collection device 12, in more detail. This process starts when a collection device 12 is connected to a control pod 10. If the collection device 12 is new to the control pod 10 or is not properly authorised, the method proceeds to the step of adding the collection device 12 to an authorised device list of the control pod 10. The collection device 12 is allocated a unique identity by the control pod 10 and is then registered to the control pod 10 using the unique identities stored by each device. The step indicated by the arrow (B) in FIG. 3 is the step of updating the device history log on the control pod 10 with the detail of the respective method step. Correspondingly, the step indicated by the arrow (A) in FIG. 3 is the step of updating the log on the collection device 12.

If the collection device 12 contains old data, or after the collection device 12 has been added to the authorised devices list, then the method proceeds to the step of forensically wiping and verifying the collection device 12. This process ensures that no prior data remains on the collection device 12, in order to maintain the integrity of the process. This verification will be checked, and if the verification is ok, the process moves to the next step and updates the log on the control pod 10 and the log on the connection device 12 with the relevant information. If the verification fails for any reason, then this process can be retried or the collection device 12 can be discarded. The device history log on the collection pod 10 will be updated accordingly.

Once the verification procedure has been completed, then the collection device 12 is marked as clean and the control pod 10 will configure the collector payload on the collection device 12. This process requires the user who is operating the system to make choices about the data that is to be captured from the target device 14. This can be done directly by the user or the user can select a predesigned profile of the data to be captured. A new profile can also be created. The profile may define a complete forensic image of the target storage device or a subset of the files to be copied. This subset may be those files accessed in the last six weeks with specific file extensions, for example. Live and/or deleted files can also be chosen in the profile as well as capturing only a portion of the file to be copied, such as the first x bytes or the first and last y bytes of the file, for example. The collection device 12 is then marked as configured.

The next step in the process is the connection of the collection device 12 to the target device 14. This connection may be direct, in the case of a laptop, for example, or may be via the control pod 10, in the case of a USB stick, for example. Data is written to the evidence partition 22 of the collection device 12, according to the configuration performed previously. Data which matches the profile present on the collection device 12 is copied to the collection device 12. Once this process is complete, the collection device 12 is marked as containing new data. The collection device 12 is then connected to the control pod 10.

The reports partition 24 of the collection device 12 is then designated as read/write. An analysis of the contents of the collection device 12 is carried out and an output is created in the reports partition 24 of the collection device 12. The collection device 12 is then marked as containing processed data. The user can then review the results of the automatic analysis by the control pod 10 of the data stored on the collection device 12. If the user wishes to keep the data/files copied during the forensic process, then they can mark the collection device 12 as evidence. If the user does not wish to keep the data/files recovered, then they can discard the data and reuse the collection device 12.

It is possible to use encryption to speed up the cleaning process, see FIG. 4. In this alternative method, the data collected on a collection device 12 can be encrypted in such a manner that in the absence of the encryption key it becomes impossible to decrypt the collected data. The steps in FIG. 4 that are either new or amended with respect to FIG. 3, are shown in dashed lines to illustrate the changes in this embodiment of the processing method.

In this second embodiment of the method, when a new or previously unused collection device 12 is attached to the control pod 10, the collection . device 12 is first wiped to forensic standards, then a small partition is created in order to store an encryption key. This area is referred to as the Key Space or K(x). Also during this process, the control pod 10 generates a unique encryption Key called K1 and stores it in K(x) on the collection device 12. A copy of K1 is also stored in the device history log that is maintained on the control pod 10.

When the collection device is configured, the control Pod stores the configuration data and the collector payload in the key space, K(x) on the collection device 12. During deployment, the collector payload is run and collects data from the target device 14. The collected data is encrypted using the key (K1) stored in the key space and subsequently stored in the EVIDENCE partition on the collection device 12. When the collection device 12 is plugged back into the control pod and the analysis process initiated, the subsequent output is also encrypted using the key K1 found in the key space. The resultant encrypted data is then stored in the REPORTS partition. Thereafter, the data in the reports partition is accessed by the control pod software using the key in K1 to decrypt it.

When instructed by the user to prepare a previously used collection device 12 for re-use, the control pod 10 deletes and over writes only the contents of the key space area of the collection device 12 thus removing the ability to interpret the data in the EVIDENCE and REPORTS partitions of the collection device 12. The control pod software then generates and writes a new encryption key (K2) and stores it in the key space K(x) on the collection device 12. It also logs this new encryption key in the collection device history log on the control pod 10. The previously collected data stored in the various partitions on the collection device 12 cannot now be interpreted because the key stored on the collection device 12 has changed.

When the collection device 12 is re-deployed on a target device 14, the collector payload performs the collection according to its configuration and encrypts the results using the new key K2 stored in the key space on the collection device 12 before storing the data in the appropriate partition on the collection device 12. When the user requests the control pod 10 to analysis the data on the collection device 12, the control pod software reads the encryption key K2 stored on the collection device 10 and decrypts the collected data, storing the resultant report data in the REPORTS partition 24 on the collection device 12.

In this way, and by referring to the previous collection sessions encryption keys (K1, K2 etc) stored in the collection device history log on the control pod 10, it is possible to forensically identify, isolate and prove which data belongs to the current collection data and which belongs to historically collected data, if any is still present, on any given collection device 12 as each set of data will only be interpretable if it is viewed using the encryption key that it was encrypted with, a copy of which is stored in the collection device history log on the control pod 10.

By using the encryption key currently stored in K(x) on the collection device this method ensures that only data collected using the same key can only be viewed and cannot be confused with previously collected data stored on the Collection device using the previous contents of K(x) during a previous data collection process. Using the above technique, it is possible to avoid the need to forensically wipe all the existing data on a collection device 12, a process that may take several hours and, instead, wipe only that very small area of the collection device 12 called the key space that contains the collection's encryption key.

1. A digital forensic system for performing forensics on a target device comprising:
a control pod with a unique identity, and
a collection device with a unique identity,
wherein,
the control pod is arranged to register the collection device with the control pod using the unique identities,
the control pod is arranged to clean the collection device,
the control pod is arranged to load a profile onto the collection device, the profile defining data to be collected,
the collection device is connected to the target device,
the collection device is arranged to copy data from the target device to the collection device according to the profile,
the control pod is arranged to create a report on the collection device, the report derived from the copied data,
the control pod is arranged to receive a user input indicating that the collection device be marked as evidence, and
the control pod is arranged to lock the collection device in response to the user input.

2. The system according to claim 1, wherein the control pod includes one or more write protected interfaces for connecting to the target device.

3. The system according to claim 1, wherein the control pod includes one or more read/write interfaces for connecting to the collection device.

4. The system according to claim 1, wherein the collection device comprises one or more write protected interfaces for connecting to the target device.

5. The system according to claim 1, wherein the control pod comprises one or more storage slots for physically storing the collection device.

6. The system according to claim 1, wherein the collection device is partitioned into an evidence partition and a report partition.

7. The system according to claim 1, wherein the control pod is further arranged to store a log of all actions made with respect to the collection device.

8. The system according to claim 1, wherein the collection device is further arranged to store a log of all actions made with respect to the collection device since the last cleaning operation.

9. The system according to claim 1, wherein the control pod is further arranged to allocate the unique identity to the collection device.

10. A method for operating a digital forensic system for performing forensics on a target device, the system comprising a control pod and a collection device, each with a unique identity, the method comprising the steps of:
registering the collection device with the control pod using the unique identities
cleaning the collection device,
loading a profile onto the collection device, the profile defining data to be collected,
connecting the collection device to the target device,
copying data from the target device to the collection device according to the profile,
creating a report on the collection device, the report derived from the copied data,
receiving a user input indicating that the collection device be marked as evidence, and
locking the collection device in response to the user input.

11. The method according to claim 10, further comprising partitioning the collection device into an evidence partition and a report partition.

12. The method according to claim 10, further comprising storing a log of all actions made with respect to the collection device at the control pod.

13. The method according to claim 10, further comprising storing a log of all actions made with respect to the collection device since the last cleaning operation at the collection device.
